(19) United States
(12) Patent Application Publication
(10) Pub. No.: US 2024/0016102 A1
(43) Pub. Date: Jan. 18, 2024

(54) GREENHOUSE SMART LIGHT CONTROL

(71) Applicant: Culception Ltd., Yehud-Monosson (IL)

(72) Inventors: Roy ELYAKIM, Ganei Tikva (IL); Michael KARP, Tel Aviv (IL); Kfir COHEN, Givat Shmuel (IL); Vladyslav LANDA, Petach Tikva (IL); Yaakov GOZLAN, Alfei-Menashe (IL)

(73) Assignee: Culception Ltd., Yehud-Monosson (IL)

(21) Appl. No.: 17/862,517

(22) Filed: Jul. 12, 2022

(51) Int. Cl. A01G 9/24; A01G 9/22

(52) U.S. Cl. CPC A01G 9/249; A01G 9/22

(57) ABSTRACT

Disclosed herein are systems and methods for controlling illumination in a greenhouse, comprising obtaining a geometric model of a greenhouse comprising a grow space segmented to a plurality of grow sections each associated with a respective one of a plurality of dimmable lamps having an illumination area overlapping the respective grow section, computing a shade model for the greenhouse based on the geometric model, the shade model defines, for each of the plurality of grow sections, a respective shading pattern indicative of a level of direct sun light in the respective grow section, enhancing the shade model using one or more machine learning models trained to predict the level of direct sun light in each grow section, and operating one or more of the plurality of dimmable lamps based on the enhanced shade model to illuminate its associated grow section according to one or more illumination rules.

### FIELD AND BACKGROUND OF THE INVENTION

The present invention, in some embodiments thereof, relates to controlling illumination in a greenhouse, and, more specifically, but not exclusively, to controlling illumination in a greenhouse to complement natural light using a plurality of dimmable lamps deployed in the greenhouse which are individually controlled based on a shade model computed for the greenhouse.

Controlled agriculture where crops are grown in environmentally controlled spaces is not new but is constantly and rapidly growing since demand for agricultural products is always on the rise.

Controlling the crops' growing environmental conditions, for example, light, water, fertilization, heat, humidity, pesticides, and/or the like may significantly improve the agricultural products in a plurality of aspects. First availability of agricultural products may be increased since crops that cannot be otherwise grown in one or more geographical areas may be grown in controlled environment spaces in these areas.

In addition, controlling the crops' environmental conditions may significantly improve the crops in one or more ways, for example, increase crops yield, improve quality, ensure higher consistency to name just a few.

Photosynthesis of the crops grown in the controlled environments was long past proved to be one of the key factor and indicators for quality agricultural products.

Light control employed for controlling light systems deployed in the controlled environment to maintain optimal light and illumination conditions per crop type, needs and/or characteristics may be therefore essential for effective and efficient controlled agriculture.

### SUMMARY OF THE INVENTION

According to a first aspect of the present invention there is provided a system for controlling illumination in a greenhouse, comprising one or more processors configured to:
Obtain a geometric model of a greenhouse comprising a grow space segmented to a plurality of grow sections each associated with a respective one of a plurality of dimmable lamps having an illumination area overlapping the respective grow section.
Compute a shade model for the greenhouse based on the geometric model, the shade model defines, for each of the plurality of grow sections, a respective shading pattern indicative of a level of direct sun light in the respective grow section.
Enhance the shade model using one or more machine learning models trained to predict the level of direct sun light in each grow section.
Operate one or more of the plurality of dimmable lamps based on the enhanced shade model to illuminate its associated grow section according to one or more illumination rules.

According to a second aspect of the present invention there is provided a computer implemented method of controlling illumination in a greenhouse, comprising using one or more processors for:
Obtaining a geometric model of a greenhouse comprising a grow space segmented to a plurality of grow sections each associated with a respective one of a plurality of dimmable lamps having an illumination area overlapping the respective grow section.
Computing a shade model for the greenhouse based on the geometric model, the shade model defines, for each of the plurality of grow sections, a respective shading pattern indicative of a level of direct sun light in the respective grow section.
Enhancing the shade model using one or more machine learning models trained to predict the level of direct sun light in each grow section.
Operating one or more of the plurality of dimmable lamps based on the enhanced shade model to illuminate its associated grow section according to one or more illumination rules.

In a further implementation form of the first and/or second aspects, the one or more illumination rules define an illumination level of the one or more dimmable lamp.

In a further implementation form of the first and/or second aspects, the one or more illumination rules define one or more spectral ranges of artificial illumination of the one or more dimmable lamps.

In a further implementation form of the first and/or second aspects, the one or more illumination rules define operating the one or more dimmable lamps to emit a level of artificial illumination such that the level of a cumulative illumination comprising the direct sun light and the artificial illumination is uniform across the plurality of grow sections.

In a further implementation form of the first and/or second aspects, the one or more illumination rules are adjusted according to one or more growth parameters of one or more crops grown in the greenhouse.

In a further implementation form of the first and/or second aspects, the geometric model is created based on a mechanical structure of the greenhouse.

In a further implementation form of the first and/or second aspects, the shading pattern of each grow section is indicative of the level of direct sun light in the respective grow section during all daytime.

In an optional implementation form of the first and/or second aspects, the shade model is adjusted according to one or more geolocation attributes of the greenhouse which potentially affect an angle of the sun with respect to one or more of the plurality of grow surfaces. The one or more geolocation attributes are members of a group consisting of: latitude, longitude, altitude, and/or orientation.

In an optional implementation form of the first and/or second aspects, the shade model is adjusted according to one or more position attributes of the greenhouse which potentially affects an angle of the sun with respect to one or more of the plurality of grow surfaces. The one or more position attributes are members of a group consisting of: an orientation, and/or a rotation.

In a further implementation form of the first and/or second aspects, the one or more machine learning models are trained to predict the level of direct sun light illuminating each of the plurality of grow sections according to the level of direct sun light measured by one or more reference sensors deployed in the greenhouse.

In a further implementation form of the first and/or second aspects, the one or more machine learning models are trained using one or more training datasets comprising a plurality of labeled training samples indicative of the level of direct sun light illuminating each of the plurality of grow sections with respect to the level of direct sun light measured by the one or more reference sensors.

In a further implementation form of the first and/or second aspects, the plurality of labeled training samples are further indicative of the level of direct sun light illuminating each of the plurality of grow sections with respect to the level of direct sun light measured by the one or more reference sensors during all sun light hours of the day.

In a further implementation form of the first and/or second aspects, at least some of the plurality of labeled training samples are captured by a plurality of light sensors deployed in a plurality of grow sections of one or more reference greenhouses representative of the greenhouse.

In a further implementation form of the first and/or second aspects, at least some of the plurality of labeled training samples are adjusted according to one or more geolocation attributes of the greenhouse with respect to a respective geolocation attribute of the one or more reference greenhouses. The one or more geolocation attributes which potentially affect an angle of the sun with respect to one or more of the plurality of grow surfaces are members of a group consisting of: latitude, longitude, altitude, and/or orientation.

In a further implementation form of the first and/or second aspects, at least some of the plurality of labeled training samples are adjusted according to one or more position attributes of the greenhouse with respect to a respective position attribute of the one or more reference greenhouses. The one or more position attributes which potentially affects an angle of the sun with respect to one or more of the plurality of grow surfaces are members of a group consisting of: an orientation, and/or a rotation.

In an optional implementation form of the first and/or second aspects, at least some of the plurality of labeled training samples are captured in a plurality of reference greenhouses deployed in a plurality of geolocations.

In a further implementation form of the first and/or second aspects, at least some of the plurality of labeled training samples are captured by a plurality of light sensors temporarily deployed in the plurality of grow sections of the greenhouse.

In a further implementation form of the first and/or second aspects, the one or more machine learning models are further trained online post deployment using a plurality of new labeled training samples captured by a plurality of light sensors deployed in one or more of the plurality of grow sections of the greenhouse.

In a further implementation form of the first and/or second aspects, each of the plurality of dimmable lamps is powered by a respective one of a plurality of power drivers, each of the plurality of power drivers is individually controllable independently of any other of the plurality of power drivers.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of controlling illumination in a greenhouse by individually operating a plurality of dimmable lamps deployed in the greenhouse, according to some embodiments of the present invention; and

FIG. 2 is a schematic illustration of an exemplary system for controlling illumination in a greenhouse by individually operating a plurality of dimmable lamps deployed in the greenhouse, according to some embodiments of the present invention.

### DESCRIPTION OF SPECIFIC EMBODIMENTS OF THE INVENTION

The present invention, in some embodiments thereof, relates to controlling illumination in a greenhouse, and, more specifically, but not exclusively, to controlling illumination in a greenhouse to complement natural light using a plurality of dimmable lamps deployed in the greenhouse which are individually controlled based on a shade model computed for the greenhouse.

According to some embodiments of the present invention, there are provided methods, systems and computer program products for controlling illumination (light) in a greenhouse comprising a grow space (area) adapted for growing one or more types of plants, crops, and/or the like, for example, vegetable, fruit, herbs, flowers, cannabis, and/or the like.

The grow space of the greenhouse may be segmented to a plurality of grow sections which may be relatively small, for example, a table, a shelf, a cabinet, a container, a chamber and/or the like each adapted for growing one or more plants and/or crops such that one or more growing conditions, for example, light, water, fertilizers, heat, humidity and/or the like may be controlled in the greenhouse per grow section using respective control systems.

The light conditions may be controlled for the plurality of grow sections via a light system deployed in the greenhouse which comprises a plurality of dimmable lamps each associated with a respective one of the plurality of grow sections such that an illumination area of each dimmable lamp overlaps with the area of its associated grow section. Moreover, each of the dimmable lamps may be controlled individually and independently of all the other dimmable lamps to enable individual control of the illumination separately for each grow section.

In particular, smart light control may be applied to take advantage of natural sun light illuminating the grow space of the greenhouse and control the light system, i.e., the dimmable lamps, to only supplement the sun light as needed in order to control and/or maintain illumination (light) conditions for the plants and/or crops grown in the green house.

The smart control is based controlling each of the dimmable lamps to project artificial light such that cumulative light in each grow section, i.e., the sum of direct sun light illuminating (reaching, hitting, etc.) each grow section and the artificial light projected by the dimmable lamp associated with the respective grow section, complies with one or more illumination rules.

However, rather than measuring the direct sun light illuminating each of the grow sections, the direct sun light illuminating each grow section is estimated. The direct sun light illuminating each of the grow sections may be estimated for every time of the day, specifically during day time (i.e., sunrise to sunset) based on the direct sun light measured by one or more reference light sensors (e.g., photo-resistor, spectrometer, etc.) and a shade model computed for the greenhouse.

The shade model which may define a shading pattern for each of the grow sections may be computed to reflect the shade casted by one or more blocking elements which may block the line of sight between the sun and one or more of the grow sections and may thus prevent at least some of the sun light to reach the respective grow sections.

The shade model may be computed based on a geometric model of the greenhouse expressing the mechanical structure and/or features of the greenhouse, for example, frame, walls, beams, and/or the like. The mechanical features defined by the geometric model may further include one or more additional objects which may be deployed and/or part of the greenhouse, for example, equipment, machinery, and/or the like.

As such, the geometric model, which expresses spectral relations (e.g., location, position, orientation, etc.) between the mechanical features of the greenhouse and each of the grow sections, may be analyzed to identify mechanical features which may block at least partially a line of sight between the sun and one or more of the grow sections (blocking elements) and the shading patterns may be computed accordingly to create the shade model.

Moreover, due to earth rotation, the angle between the sun and each of the grow sections is constantly changing during the day while the sun shines, the shade model may reflect the shading patterns of the grow sections throughout the daytime.

Optionally, the shade model may be adjusted according to one or more geolocation attributes (e.g., latitude, longitude, altitude) and/or orientation attributes (e.g. position, rotation, etc.) of the greenhouse since such attributes may affect the angle of the sun with respect to one or more, and potentially all of the grow sections and may thus alter their shading patterns defined by the shade model.

While at least some of the grow sections may be at least partially shaded, the reference light sensor(s) may be deployed in the greenhouse in locations where no shade may be casted on it by any of the blocking elements the reference light sensor(s) is fully exposed to direct sun light subject to environmental conditions, for example, clouds, fog, smog, and/or the like and/or external blocking elements (e.g. mountain, building, tree, etc. which may block sun light to the entire greenhouse. Since it may not be blocked (shaded) by the blocking elements, the direct sun light measured by the reference sensor(s) is the actual and maximal direct sun light illuminating the greenhouse.

The direct sun light illuminating each grow section may be therefore estimated based on the direct sun light measured by the reference sensor(s) and the shade model which defines the shading patterns for each grow section.

The shade model, however, may not be sufficiently accurate due to one or more limitations, for example, limited accuracy of mechanical data relating to the greenhouse, impact and effect of a geolocation (e.g., latitude, longitude, altitude) and/or orientation of the greenhouse which may affect an angle of the sun with respect to the greenhouse and its grow sections, and/or the like.

The shade model may be therefore enhanced using one or more trained Machine Learning (ML) models, for example, a neural network, a deep neural network, a Support Vector Machine (SVM) and/or the like.

The ML model(s) may be trained to estimate and/or predict the level of direct sun light illuminating each of the plurality of grow sections during all daytime hours. In particular, the ML model(s) may be trained to estimate the level of direct sun light in grow section based on the level of sun light measured by the reference sensor(s).

The ML model(s) may be trained through, for example, supervised training using one or more training datasets comprising a plurality of labeled training samples indicative of the level of direct sun light in each of the grow sections with respect to the level of direct sun light measured by the reference sensor(s). The training samples may be further labeled to indicate the time of day when the measurement are captured to establish training data throughout the day.

The training datasets may be created and/or collected from one or more reference greenhouses in which light sensors may be deployed to measure the direct sun light illuminating each of the grow sections and further associate the measured sun light the light with the direct sun light measured by the reference sensor(s) at the same time.

Moreover, the ML model(s) may be initialized with estimation sun illumination data computed based on the shade model. As such, the ML model(s) may not start learning and evolving from scratch but rather from a well-established prediction point derived from the shade model of the greenhouse.

Optionally, at least some of the labeled training samples may be adjusted according to one or more geolocation attributes and/or orientation attributes of the target greenhouse which may differ from respective attributes of the reference greenhouse(s).

Optionally, at least some training samples used to train the ML model(s) may be captured by a plurality of light sensors temporarily deployed in the greenhouse for a limited time data capturing period after which they may be removed. Moreover, the ML model(s) may be further trained online, post deployment, using new training samples captured by light sensors temporarily deployed in the greenhouse for a limited time.

Based on the shade model, the plurality of lamps may be individually controlled to supplement the natural light estimated at each grow section according to one or more illumination rules defining one or more illumination conditions for one or more of the grow sections in the greenhouse.

The illumination rules may define, for example, one or more illumination levels for one or more of the grow section. In another example, the illumination rules may define one or more spectral ranges for illuminating one or more of the grow sections. In another example, the illumination rules may define uniform illumination level across multiple and possibly all of the grow sections.

The smart light control for controlling illumination conditions of plants and/or crops grown in a greenhouse may present major benefits and advantages compared to currently existing methods and systems for controlling light in greenhouses.

First, most of the existing systems and methods are configured to control greenhouse illumination with little and typically with no consideration of the sun light illuminating (hitting) the plants and/or crops grown in the greenhouse.

Ignoring the contribution of sun light on the illumination of the plants may introduce major limitations since in order to control and/or maintain a certain illumination level in the greenhouse, the illumination system of the greenhouse may be operated to provide the entire required illumination.

One major such limitation lies in the fact that different parts and/or grow sections of the greenhouse may be illuminated by different levels of direct sun light. Illuminating all grow sections with artificial light regardless of the natural sun light they receive may result in a different cumulative light, i.e., the sum of the natural and artificial light, in different grow sections. The non-uniform illumination across the greenhouse may lead to differences in the products, yield, and/or other growth parameters and/or results of the plants and/or crops grown in different grow sections even if in the same greenhouse.

In addition, operating the illumination system to provide the entire illumination required across all grow sections of the greenhouse may be extremely high energy demanding.

In contrast, applying the smart light control which takes advantage of the natural sun light illuminating each of the grow sections may allow controlling the light system, i.e., the dimmable lamps to only supplement the natural sun light estimated in each grow section. As result, the cumulative illumination, i.e., the combined natural and artificial light, may be accurately controlled, for example, to maintain a uniform illumination level across all grow sections in the greenhouse and even between multiple greenhouses. Maintaining accurate and/or uniform illumination may significantly increase quality, uniformity and/or consistency of the products, yield, and/or other growth parameters and/or results of the plants and/or crops grown in the greenhouse and possibly across multiple greenhouses.

Moreover, since the dimmable lamps are operated to only supplement the sun light illumination, the energy invested to operate the dimmable lamps may be significantly lower compared to the energy consumed by the existing light systems which may be operated to provide the entire illumination which combined with the natural sun light may be excessive and therefore at least partially redundant.

Furthermore, segmenting the grow space of the greenhouse to the plurality of grow sections and associating each grow section with a respective individually controlled dimmable lamp configured to illuminate only the associated grow section may enable focused illumination per grow section. Such focused illumination per relatively small sections of the greenhouse may be significantly more efficient, accurate and/or consistent compared to illuminating large spaces of the greenhouse and even the entire greenhouse with the same illumination (parameters) as may be done by the existing light control systems.

Also, estimating the level of direct sun light each of the grow rather than deploying sensors to actually measure the level of direct sun light may significantly reduce complexity, cost and/or effort compared to such sensor deployment which may be highly extensive since the number of grow sections may be significantly large. Deploying multiple sensors in the greenhouse may require, in addition to the cost of the sensors, additional wiring, power and/or communication infrastructure which may further increase complexity and/or cost both for the initial deployment and also for maintenance. On the other hand, estimating the level of direct sun light based on measurement captured by only few and typically only one reference sensor may therefore significantly reduce the complexity, cost and/or effort for determining the sun light level at each of the grow sections.

Using ML model(s) to estimating the level of direct sun light each of the grow sections may also be highly advantageous since it may significantly increase accuracy, consistency and/or reliability of the estimation (prediction) compared to pure analytical computation applied to estimate the sun light level based on a shade model created for the greenhouse based on its geometric model and structural features. This is because the shade model may be subject to one or more limitations. For example, dimensions of the geometrical model may be inaccurate, for example, due to gaps between greenhouse plans and actual build. In another example, one or more blocking features and/or elements which are not obvious in the geometrical model may affect the shading patterns computed for one or more of the grow sections. In another example, one or more of the position and/or geolocation attributes of the greenhouse may affect the shading patterns computed for one or more of the grow sections in a way that may not be accounted for in an analytical analysis of the mechanical structure of the greenhouse.

Applying ML model(s) to estimate the sun light level in each of the grow section may overcome the limitations of the geometrical model analytical analysis described herein before since the ML model(s) trained with real-world data samples may learn and adapt accordingly thus reducing and potentially eliminating reliance on the analytical model only.

However, using the initial shade model, computed based on the geometrical and mechanical model of the greenhouse, as baseline for the ML model(s) may significantly expedite and/or improve the training process of the ML model(s). First, since the ML model(s) start training from the initial shade model baseline, the cold start problem inherent to ML may be overcome and the training time may be significantly reduced since the ML model(s) may converge significantly faster compared to training started from scratch with no baseline. In addition, since the training time is reduced, the computing resources, for example, processing resources, storage resources and/or the like applied for the training may be also significantly reduced. Also, using the baseline as the starting point for training the ML model(s) may significantly reduce the number of training samples required for the training process.

Moreover, further training the ML model(s) online, post deployment, may further increase accuracy, reliability, and/or consistency of the light level prediction since the ML model(s) may learn and adapt according to the specific conditions applicable for the specific greenhouse which the ML model(s) are deployed to support.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

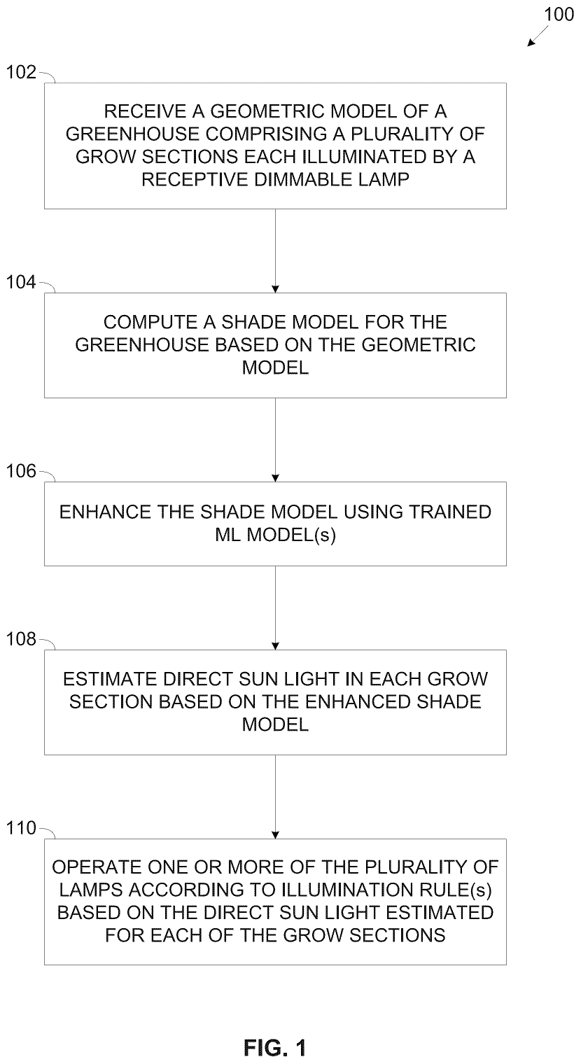

Referring now to the drawings, FIG. 1 is a flowchart of an exemplary process of controlling illumination in a greenhouse by individually operating a plurality of dimmable lamps deployed in the greenhouse, according to some embodiments of the present invention.

An exemplary process 100 may be executed to control illumination conditions (light) in one or more greenhouses having a grow space (area) adapted for growing one or more types of plants, crops, and/or the like, for example, vegetable, fruit, herbs, flowers, cannabis, and/or the like.

In particular, smart control may be applied to take advantage of natural sun light illuminating the grow space and control one or more illumination systems deployed in the greenhouse to supplement the sun light if needed in order to achieve optimal illumination (light) conditions as defined by one or more illumination rules.

The smart control is based on two main concepts applied in the greenhouse. First the grow space of the greenhouse may be segmented to a plurality of grow sections where one or more growing conditions, specifically light (illumination) conditions may be individually monitored and controlled per grow section using a plurality of individually controlled lamps each illuminating a respective one of the grow sections.

In addition, a shade model expressing shading patterns in the grow space per grow section is created and used to estimate the light conditions, i.e., natural light, specifically direct sun light hitting each grow section. The shade model computed may be created using Machine Learning (ML) applied to enhance a geometric model of the greenhouse.

Based on the shade model, the plurality of lamps may be individually controlled to supplement the natural light estimated at each grow section according to one or more illumination rules.

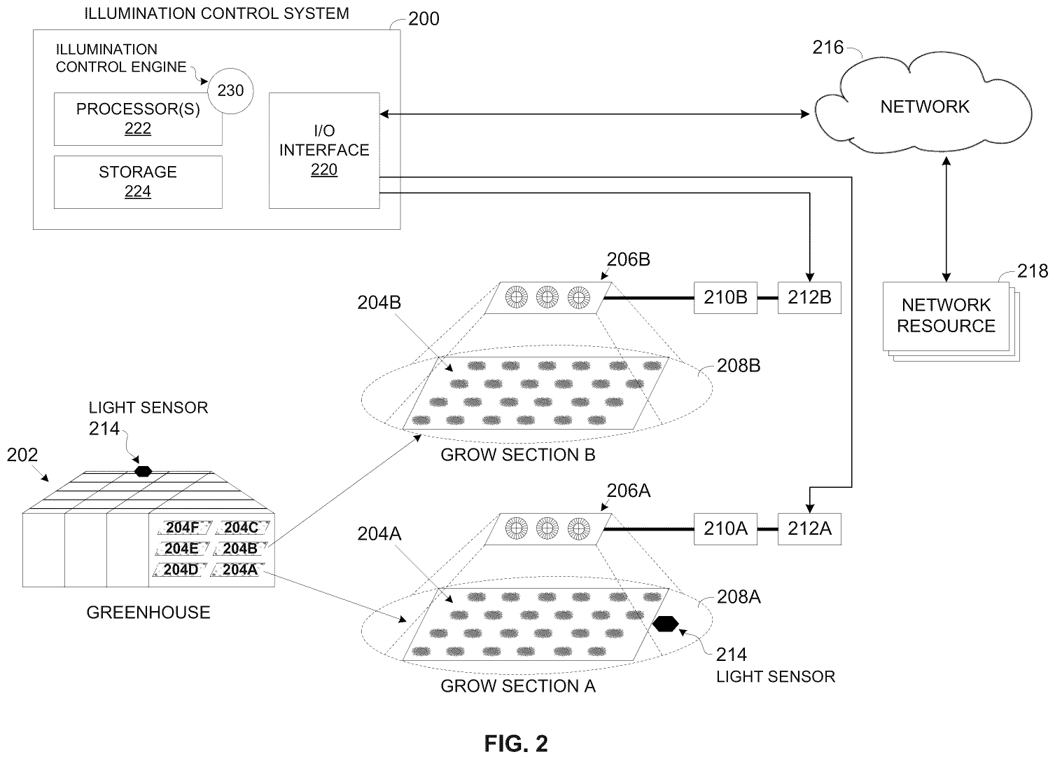

The shade model Reference is also made to FIG. 2, which is a schematic illustration of an exemplary system for controlling illumination in a greenhouse by individually operating a plurality of dimmable lamps deployed in the greenhouse, according to some embodiments of the present invention.

An exemplary illumination control system 200 may be deployed to control illumination (light) in a grow space of a greenhouse 202 in which one or more plants and/or crops may be grown, for example, vegetable, fruit, herbs, flowers, cannabis, and/or the like.

The grow space of the greenhouse 202 may be segmented to a plurality of grow sections 204, for example, a table, a shelf, a cabinet, a container, a chamber and/or the like each configured for growing one or more plants and/or crops. The grow space is segmented to the plurality of grow sections 204, for example, grow section A 204A, grow section B 204B, grow section C 204C, grow section D 204D, grow section E 204E, grow section F 204F and so on such that one or more growing conditions, for example, light (illumination), water, fertilization, heat, humidity, and/or the like may be individually monitored and/or controlled per grow section via one or more distributed systems, and/or infrastructures deployed in the greenhouse 202.

Specifically, growing light (illumination) conditions, for example, light level, light spectrum, and/or the like may be controlled individually for each of the grow sections 204 to achieve optimal photosynthesis conditions for the plants grown in the grow sections which may significantly increase one or more attributes of the plants, for example, crop products yield, crop products quality, crop products uniformity, and/or the like.

The light level indicating a level and/or an amount of light hitting, reaching and/or illuminating each grow section 204 may be expressed using one or more metrics and/or units, for example, irradiance, specifically irradiance of Photosynthetically Active Radiation (PAR)), Photosynthetic Photon Flux (PPF), Photosynthetic Photon Flux Density (PPFD), and/or the like.

The light spectrum may include one or more spectral regions which are effective for photosynthesis, as known in the art, typically in the visible light range of 400-700 nanometers.

In order to support individual illumination control of each grow section 204, each grow section 204 is associated with a respective one of a plurality of dimmable lamps 206 having an illumination area 208 which overlaps the respective grow section 204. In other words, each dimmable lamp 206 has a limited illumination area and is therefore capable of illuminating only a limited area which overlaps with its associated grow section 204. For example, the grow section 204A may be associated with a dimmable lamp 206A having an illumination area 208A which overlaps with the area of the grow section 204A. In another example, the grow section 204B may be associated with a dimmable lamp 206B having an illumination area 208BA which overlaps with the area of the grow section 204B.

Each dimmable lamp 206 may support dimming, i.e., projection (emission) of light at various light levels. Each dimming lamp 206 may therefore comprise one or more light emission units and/or light sources of one or more types and/or technologies which support dimming, for example. Light-Emitting Diodes (LED). High-Intcnsity Discharge (HID) lamps, fluorescent lights, incandescent lamps, and/or the like.

In order to control the dimmable lamps 206 independently of each other, each dimmable lamp 206 may be powered by a respective power source which is individually controlled such that power may be individually driven to each dimmable lamp 206 to control its illumination parameters accordingly. For example, each dimmable lamp 206 may be powered by a respective power driver 210 which is controlled by a respective power controller 212 where each power controller 212 may be individually and independently controlled by the illumination control system 200. For example, the dimmable lamp 206A may be powered by a respective power driver 210A controlled by a respective power controller 212A while the dimmable lamp 206B may be powered by a respective power driver 210B controlled by a respective power controller 212B.

The power architecture described herein is exemplary and should not be construed as limiting since a plurality of alternative power schemes, deployments and/or infrastructures, as may be apparent to a person skilled in the art, may be employed to individually control each dimmable lamp 206. For example, a single power driver may be configured to drive multiple dimmable lamps 206 each via a respective power port, interface, line and/or the like. In another example, the power driver 210 may be integrated with the power controller 212 thus forming a smart power driver having communication capabilities such that is may be directly connected and controlled by the illumination control system 200.

The power controllers 212 may be configured to control one or more power parameters of the power driven out of each power driver 210 to its respective dimmable lamp 206, for example, voltage, current, and/or the like.

The power controllers 212 may be configured to support a plurality of interfaces for connecting and controlling their respective lamp power drivers 210. Such interfaces may include, for example, one or more analog and/or digital interfaces such as, for example, Pulse Width Modulation (PWM), Analog to Digital Converter (ADC), Digital to Analog Converter (DAC), and/or the like. Additionally. and/or alternatively, the interfaces of the power controllers 212 for controlling the power drivers 210 may include one or more digital interfaces such as, for example, serial bus. Universal Serial Bus (USB), and/or the like.

The power driven to each dimmable lamp 206 by its respective power driver 210 may obviously define, set and/or yield the illumination parameters of the respective dimmable lamp 206, for example, the illumination level.

The illumination level (dimming) of the lamps 206 may be controlled and/or set according to one or more operation modes, scales and/or ranges. For example, one or more of the dimmable lamps 206 may be dimmed in continuous mode such that the dimmable lamps 206 may be controlled to emit light in a continuous scale from no light (0% of the lamp's emission capacity) to full light (100% emission). In another example, one or more of the dimmable lamps 206 may be dimmed in discrete mode to a plurality of discrete levels. The discrete levels may be set and/or predefined (static) and/or dynamically set to one or more other setting schemes. For example, a first scheme may define 5 diming levels, for example, 0% emission capacity, 25% emission capacity, 50% emission capacity, 75% emission capacity and 100% emission capacity. In another exemplary scheme, the discrete levels may be defined for higher granularity, for example, 0% emission capacity, 10% emission capacity, 20% emission capacity, 30% emission capacity and so on to 100% emission capacity.

The illumination control system 200, for example, a controller, a computer, a server, a computing node, a cluster of computing nodes and/or the like may include an Input/Output (I/O) interface 220, a processor(s) 222, and a storage 224 for storing data and/or computer program code (program store).

The I/O interface 220 may include one or more wired and/or wireless I/O interfaces, ports and/or interconnections, for example, a serial bus interface (RS-422, RS-485, etc.), a CAN bus interface, a Bluetooth (BT) interface, a Radio Frequency (RF) interface, and/or the like. The I/O interface 220 may also include one or more wired and/or wireless network interfaces, for example, a Local Area Network (LAN) interface, a Wireless LAN (e.g. Wi-Fi) interface, and/or the like.

Via the I/O interface 220, the illumination control system 200 may connect and communicate with one or more external devices, in particular with the power controllers 212 deployed and configured to control the power drivers 210 and the parameter(s) of the power these power drivers 210 drive to the dimmable lamps 206.

One or more architectures may be applied for connecting the power controllers 212 to the illumination control system 200. For example, a plurality of power controllers 212, optionally all power controllers 212 may be connected to the illumination control system 200 via a wired multi-drop bus, for example, RS-485. In another example, one or more of the power controllers 212 may be each individually connected to the illumination control system 200 via a wired point-to-point channel, for example, RS-422. In another example, one or more of the power controllers 212 may be connected to the illumination control system 200 via one or more RF wireless channels and/or networks, for example, BT. WLAN, a proprietary RF channel and/or the like.

The illumination control system 200 may apply one or more communication protocols for communicating with the power controllers 212. One or more of the communication protocols used by the illumination control system 200 may be designed, configured and/or applied to reduce traffic and bandwidth of the communication channel(s) connecting one or more of the power controllers 212 to the illumination control system 200.

Moreover, one or more proprietary communication protocols used by the illumination control system 200 which define message data structures which are not public knowledge in order to increase security and safety of the exchanged data in attempt to prevent malicious eavesdropping and/or intervention in the operation of the illumination control system 200 and/or the power controllers 212

Optionally, the data exchanged between the illumination control system 200 and one or more of the power controllers 212 may be encrypted using one or more encryption protocols, algorithms and/or methods to further increase security and safety of the data exchanged between the illumination control system 200 and the power controllers 212.

The illumination control system 200 may further obtain light illumination (light) readings measured by one or more sensors, for example, light sensors 214 such as, for example, a photo-resistor, a spectrometer, and/or the like. The light sensor(s) 214 may be deployed in the greenhouse 202 to measure one or more illumination conditions, for example, light level, light spectrum and/or the like.

The illumination control system 200 may communicate directly with the light sensor(s) 214 to collect the illumination conditions measured by the light sensor(s) 214. In another example, the illumination control system 200 may communicate with one or more other systems, devices, services and.ro the like configured to collect the illumination conditions readings captured by the light sensor(s) 214.

The light sensor(s) 214 may be configured to measure level of direct sun light on the greenhouse 202. As such, the light sensor(s) 214 may be indicative of the level of sun light reaching (hitting) the greenhouse 202 which may be affected by one or more conditions, for example, clouds, fog, smog, smoke, and/or the like.

The light sensor(s) 214 which may serve as global sensor(s) for reference as described in detail hereinafter may include only few and possibly only one light sensor(s) 214 deployed in one or more locations having direct line of sight to the sun during the entire daytime, i.e., from sunrise to sunset. In order to ensure their direct line of sight to the sun, the light sensor(s) 214 may be deployed in the greenhouse 202 where no blocking elements may block this line of sight and cast a shadow on the light sensor(s) 214.

The blocking elements may include, for example, elements within the greenhouse 202 itself, for example, structural elements of the greenhouse 202, equipment deployed in the greenhouse 202, plants growing in the grow space 204 of the greenhouse 202, and/or the like. However, the blocking elements may further include one or more external elements, for example, a structure, a building, a tree, and/or the like located around the greenhouse 202 such that they may cast shadow on the greenhouse 202.

For example, one or more light sensor(s) 214 may be deployed on a roof of the greenhouse 202. In another example, one or more light sensor(s) 214 may be deployed in one or more of the grow sections 204, for example, grow section A 204A assuming no blocking elements may block the direct line of the sight between the sun and the light sensor 214 in grow section A 204A. In another example, multiple light sensors 214 may be deployed a plurality of locations in the greenhouse 202, for example, in several grow sections 204 such that at least one of the multiple light sensors 214 has a direct line of sight to the sun at every time during the daytime.

Optionally, the illumination control system 200 may connect, via the I/O interface 220, to a network 216 which may comprise one or more wired and/o wireless networks, for example, a LAN, a WLAN, a Wide Area Network (WAN), a Metropolitan Area Network (MAN), a cellular network, the internet and/or the like. Via the I/O interface 220, the illumination control system 200 may communicate with one or more remote network resources 218 connected to the network 216, for example, a server, a storage server, a cloud service, and/or the like.

The processor(s) 222, homogenous or heterogeneous, may include one or more processing nodes arranged for parallel processing, as clusters and/or as one or more multi core processor(s).

The storage 224 may include one or more non-transitory memory devices, either persistent non-volatile devices, for example, a ROM, a Flash array, a hard drive, an SSD, and/or the like as well as one or more volatile devices, for example, a RAM device, a cache memory and/or the like. The storage 224 may further comprise one or more local and/or remote network storage resources, for example, a storage server, a Network Attached Storage (NAS), a network drive, a cloud storage service and/or the like accessible via the network I/O interface 220.

The processor(s) 222 may execute one or more software modules, for example, a process, a script, an application, an agent, a utility, a tool, an Operating System (OS), a service, a plug-in, an add-on and/or the like each comprising a plurality of program instructions stored in a non-transitory medium (program store) such as the storage 224 and executed by one or more processors such as the processor(s) 222.

Optionally, the processor(s) 222 may include, utilize and/or apply one or more hardware elements available in the illumination control system 200, for example, a circuit, a component, an Integrated Circuit (IC), an ASIC, an FPGA, a Digital Signals Processor (DSP), a Graphic Processing Unit (GPU), an Artificial Intelligence (AI) accelerator, and/or the like.

The processor(s) 222 may therefore execute one or more functional modules utilized by one or more software modules, one or more of the hardware modules and/or a combination thereof. For example, the processor(s) 222 may execute an illumination control engine 230 configured to execute the process 100.

Optionally, the illumination control system 200, specifically, the illumination control engine 230 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like.

For brevity, the process 100 is presented and described for controlling illumination in a single greenhouse 202. This, however, should not be construed as limiting since the process 100 may be easily expanded and scaled for controlling the illumination in multiple greenhouses such as the greenhouse 202.

As shown at 102, the process 100 starts with the illumination control engine 230 receiving, fetching, retrieving and/or otherwise obtaining a geometric model of the greenhouse 202.

For example, the illumination control engine 230 may communicate with one or more of the network resources 218 to receive the geometric model of the greenhouse 202. In another example, the illumination control engine 230 may locally store the geometric model of the greenhouse 202 and may therefore fetch it from the local storage, for example, the storage 224. In another example, the illumination control engine 230 may retrieve the geometric model of the greenhouse 202 from one or more attachable storage devices, for example, a memory stick attached to one or more ports of the I/O interface 220, for example, a USB port.

While the greenhouse 202 is typically covered by cover sheets which are configured to provide and support optimum sun light transmission, the greenhouse 202 may comprise a plurality of structural elements, for example, a frame, a beam, a wall, and/or the like which may block at least partially the sunlight path to one or more of the grow sections 204 of the greenhouse 202 and/or part thereof.

The geometric model which may be created based on a mechanical structure of the greenhouse 202 and may define one or more geometrical attributes, for example, location, position, orientation, elevation, width, length, height, and/or the like of these structural elements of the greenhouse 202. The geometric model of the greenhouse may be implemented using one or more methodologies, implementations, and/or layouts as known in the art, for example, a 2 Dimension (2D) model expressing 2D information, a Dimension (3D) model expressing 3D information, and/or the like.

As shown at 104, based on the geometric model, the illumination control engine 230 may compute a shade model for the greenhouse 202.

The shade model computed by the illumination control engine 230 may define a shading pattern for each of the plurality of grow sections 204 which is indicative of a level of direct sun light in the respective grow section 204, i.e., the level of sun light illuminating (hitting) the respective grow section 204. Moreover, the shading pattern defined by the shade model for each of the grow sections 204 may be indicative of the level of direct sun light in the respective grow section 204 during all daytime. i.e., from sunrise to sunset.

Optionally, the illumination control engine 230 may adjust the shade model according to one or more geolocation attributes of the greenhouse 202, for example, latitude, longitude, and/or altitude which may affect an angle of the sun with respect to each of the plurality of grow surfaces 204 and may thus affect the shading pattern of each grow section 204.

For example, assuming the greenhouse 202 is located in a first location at a first latitude, for example, a northern region of earth, the angle of the sun with respect to each grow section 204 may be smaller compared to the angle of the sun with respect to the grow sections 204 of the same greenhouse 202 located in a second location at a latitude closer to the earth's equator. The different angles may affect the shades (shadows) casted by one or more of the blocking elements on one or more of the grow sections 204 and the illumination control engine 230 may therefore adjust the shade model accordingly. Specifically, the illumination control engine 230 may adjust the shading pattern of the respective grow section(s) 204 to reflect the different shade casted by the blocking element(s).

The illumination control engine 230 may further adjust the shade model according to one or more position attributes of the greenhouse 202, for example, orientation, rotation, and/or the like which may potentially affect an angle of the sun with respect to one or more of the plurality of grow surfaces 204 and may thus affect the shading pattern of each grow section 204.

For example, assuming the same greenhouse 202 is oriented in a first orientation or in a second ordination at the exact same geolocation. In such case, the blocking elements, for example, the structural elements of the greenhouse 202 may be oriented (positioned, located, etc.) differently with respect to the grow sections 204 and the sun such that the shade they cast on the grow sections 204 may change. The illumination control engine 230 may therefore adjust the shade model accordingly and adjust the shading pattern of one or more of the grow sections 204 to reflect the different shade casted by the blocking elements.

As shown at 106, the illumination control engine 230 may enhance the shade model using one or more trained ML models, for example, a neural network, a deep neural network, an SVM and/or the like.

The ML model(s) may be trained to estimate and/or predict the level of direct sun light illuminating (reaching, hitting) each of the plurality of grow sections 204 during all sun light hours (daytime, i.e., from sunrise to sunset). Specifically, the ML model(s) may be trained to estimate the level of direct sun light in grow section 204 based on the level of sun light measured by one or more global sensors serving as reference sensors, for example, the light sensor(s) 214 deployed in the greenhouse 202.

Based on the light level estimated by the trained ML model for the grow sections 204, the shading patterns of one or more of the grow sections 204 may be adjusted, adapted and/or improved to create the enhanced shade model.

As described herein before, the reference sensor(s), for example, the light sensor(s) 214 may be deployed in the greenhouse 202 such that no blocking elements may cast a shadow on them and they may be therefore indicative with high accuracy of the direct sun light hitting (reaching) the greenhouse 202. Since no blocking elements block the sun for the light sensor(s) 214, the level of sun light measured by the reference light sensor(s) 214 may depend only on environmental conditions, such as clouds, fog, smog, shadows casted by external objects blocking the sun for the greenhouse 202, and/or the like.

The direct sun light that actually reaches each of the grow spaces 204 may be only reduced compared to the level of sun light measured by the reference light sensor(s) 214 due to shadows casted by one or more of the blocking elements blocking the line of sight between the sun and the respective grow section 204. The direct sun light that actually reaches each of the grow spaces 204 may be therefore estimated based on the direct sun light reaching the greenhouse 202 and the shading pattern defined for the respective grow section in the shade model.

The ML model(s) may be therefore trained to predict (estimate) the level of direct sun light illuminating each of the plurality of grow sections 204 according to the level of direct sun light measured by the reference sensor(s) deployed in the greenhouse 202, for example, the light sensor(s) 214.

In particular, the ML model(s) may be initialized with estimation data computed based on the shade model such that the ML model(s) do not start learning and evolving from scratch but rather from a well-established prediction point derived from the shade model of the greenhouse 202. For example, the level of direct sun light illuminating each of the plurality of grow sections 204 may be computed based on the shade model computed for the greenhouse 202 and fed to the ML model(s) as a baseline.

In a training phase, the ML model(s) may be therefore trained in according to one or more training modes, for example, supervised training using one or more training datasets comprising a plurality of labeled training samples indicative of the level of direct sun light in each of the grow sections 204 with respect to the level of direct sun light measured by the reference sensor(s) 214.

For example, each of the plurality of training samples may indicate the level of direct sun light in one or more of the grow sections 204 and labeled with a label indicative of the level of direct sun light measured at the same time by the reference sensor(s) 214.

During the training phase, the ML model(s) may therefore learn the relation between the level of sun light measured by the reference sensor(s) 214 and the level of sun light illuminating each of the grow sections 204. The ML model(s) may adjust, adapt and/or otherwise evolve accordingly, as known in the art. For example, a neural network based ML model comprising a plurality of nodes connected via weighted edges may form paths, adjust weights, and/or the like according to its predicted direct sun light level for the labeled training samples compared to the actual sun light level as indicated by their labels.

The training dataset(s) may further include training samples indicative of the level of direct sun light reaching (illuminating) each of the plurality of grow sections 204 with respect to the level of direct sun light measured by the reference light sensor(s) 214 (reference direct sun light level) in correlation to one or more timing attributes and/or parameters and/or a combination thereof.

For example, the training dataset(s) may include training samples indicative of the level of direct sun light reaching (illuminating) each of the grow sections 204 with respect to the reference direct sun light level during all sun light hours of the day. For example, the label of each training sample may be further indicative of the time of day which the respective training sample represents, expresses and/or corresponds to. As such, the ML model(s) may further learn the relation between the level of sun light measured by the reference sensor(s) 214 and the level of sun light illuminating each of the grow sections 204 at every time of the day, specifically during daytime when the sun is shining.

In another example, the training dataset(s) may include training samples indicative of the level of direct sun light illuminating each grow section 204 with respect to the reference direct sun light level around the year, i.e., during different dates, weeks, seasons and/or times of the year. For example, the label of each training sample may be further indicative of the date, week and/or season which the respective training sample represents, expresses and/or corresponds to. As such, the ML model(s) may further learn the relation between the level of sun light measured by the reference sensor(s) 214 and the level of sun light illuminating each of the grow sections 204 at different times, days, weeks and/or seasons of the year.

One or more methods and/or techniques may be applied to capture, collect, and/or create the training samples used to train the ML model(s) to predict the direct sun light illuminating each of the grow sections 204 based on the level of direct sun light measured by the reference sensor(s) 214.

For example, at least part of the training samples may be captured by a plurality of light sensors such as the light sensor 214 deployed in a plurality of grow sections such as the grow sections 204 of one or more reference greenhouses representative of the greenhouse 202. In such case, the light level measured by each light sensor deployed in each grow section of the reference greenhouse may be used to create training samples which may be labeled with the level of direct sun light measured by a reference light sensor such as the light sensor 214 deployed in an unblocked location in the reference greenhouse. Each training sample may further include the time of day when the measurements are captured.

Optionally, at least some of the plurality of labeled training samples may be adjusted according to one or more of the geolocation attributes of the greenhouse 202, for example, longitude, latitude, and/or altitude with respect to the respective geolocation attributes of the reference greenhouse(s). Differences in the geolocation attribute(s) between the greenhouse 202 and the reference greenhouse(s) may potentially affects the angle of the sun with respect to one or more of the grow surfaces 204 which may lead to potential differences in the shades casted by the blocking elements on one or more of the grow sections 204. The training samples may be therefore adjusted accordingly to compensate for the potential differences in the shades casted by the blocking elements.

The adjustment to the training samples may be done, for example, according to the shade model computed for the greenhouse 202 compared to a shade model computed for the reference greenhouse(s). For example, assuming the geolocation of the greenhouse 202 is at higher altitude compared to the altitude of the reference greenhouse. In such case, during at least part of the daytime, the sun angle with respect to one or more of the grow sections 204 of the greenhouse 202 may be different than the sun angle with respect to corresponding grow sections in the reference greenhouse. Such difference in the sun angle may lead to different shade casted by one or more of the blocking elements on one or more of the grow sections 204 which in turn may obviously affect the level of direct sun light illuminating these grow sections 204. The training samples may be therefore adjusted accordingly to compensate for the difference in the level of direct sun light corresponding to each grow section between the greenhouse 202 and the reference greenhouse.

Moreover, at least some of the plurality of labeled training samples may be created and/or adjusted based on measurements of direct sun light captured in a plurality of reference greenhouses deployed in a plurality of geolocations, in particular different geolocations characterized by different geolocation attributes. This means that a plurality of light sensors such as the light sensor 214 may be deployed to measure the direct sun light illuminating each of a plurality of grow sections such as the grow section 204 of each of a plurality of reference greenhouses representative of the greenhouse 202 which are located in a plurality of different geolocations.

Training the ML model(s) with labeled training samples captured, created and/or adjusted based on the sun light data captured in the plurality of different locations may enable the ML model(s) to adapt and learn the impact of the geolocation attributes on the relationship between the level of direct sun light measured by the reference sensor(s) and the level of direct sun light measured in each grow section. Adapting and learning the contribution and/or effect of the geolocation attributes may significantly improve light level prediction performance of the ML model(s), for example, accuracy, consistency, reliability and/or the like.

Optionally, at least some of the plurality of labeled training samples may be adjusted according to one or more of the position attributes of the greenhouse 202, for example, orientation, rotation, and/or the like which may potentially affect the angle of the sun with respect to one or more of the grow surfaces 204. The different sun angle may result in differences in the shades casted by the blocking elements on one or more of the grow sections 204 and the training samples may be therefore adjusted to compensate for the possible differences in the casted shades. As described before, adjustment of the training samples may be done based on the shade models computed for the greenhouse 202 and for reference greenhouse(s). For example, assuming the geolocation of the greenhouse 202 is rotated at a certain angle compared to the reference greenhouse, during at least part of the daytime, the sun angle with respect to one or more of the grow sections 204 of the greenhouse 202 may be different than the sun angle with respect to corresponding grow sections in the reference greenhouse. The training samples may be therefore adjusted to compensate for differences in the level of direct sun light at one or more of the grow sections 204 compared to corresponding grow sections of the reference greenhouse.

In another example, at least part of the training samples may be captured by a plurality of light sensors such as the light sensor 214 temporarily deployed in the greenhouse 202 to measure the level of direct sun light in each of the plurality of grow sections 204. As described herein before, each such training sample may be labeled with a label comprising the level of direct sun light measured by a reference light sensor such as the light sensor 214 deployed in in an unblocked location in the greenhouse 202 and further comprising the time of day when the measurements are captured.

For example, the plurality of light sensors may be deployed in the greenhouse for a short period of time, for example, before making the greenhouse 202 operational to capture and create training samples used for training the ML model(s). The light sensors may be then removed with only the global reference light sensor 214 left to serve as the reference sensor providing a reference direct sun light level which may be sued by the trained ML model(s) to predict the level direct sun light illuminating each grow section 204.

Optionally, the ML model(s) may be further trained online, post deployment, i.e., after trained and deployed to estimate the direct sun light illuminating each of the grow sections 204. For example, a plurality of light sensors such as the light sensor 214 may be deployed in the greenhouse 202 to capture a plurality of new training samples which may be used to further train the ML model(s). In particular, the plurality of light sensors may measure the level of direct sun light illuminating each of the grow sections 204. The new training samples may be thus created to indicate the level of direct sun light illuminating each of the grow sections 204 and labeled with the level of direct sun light measured by the reference light sensor (s) 214.

The illumination control engine 230 may therefore enhance the shade model by adjusting, adapting and/or improving the shading patterns of one or more of the grow sections 204 according to the direct sun light levels estimated by the trained ML model for the grow sections 204.

As shown at 108, the illumination control engine 230 may estimate the level of direct sun light illuminating (reaching, hitting) each of the plurality of grow sections 204 based on the enhanced shade model.

For example, the illumination control engine 230 may analyze the enhanced shade model to derive the level of direct sun light at each of the grow sections 204 based on the level of direct sun light measured by the reference light sensor(s) 214.

In another example, the illumination control engine 230 may feed the level of direct sun light measured by the reference light sensor(s) 214 into the trained ML model(s) which estimate accordingly the level of direct sun light at each of the grow sections 204.

As shown at 110, the illumination control engine 230 may operate one or more of the plurality of dimmable lamps 206 based on the enhanced shade model according to one or more illumination rules. In particular, the illumination control engine 230 may operate the dimmable lamp(s) 206 according to the illumination rule(s) based on the levels of direct sun light estimated based on the enhanced shade model to illuminate each of the grow sections 204.

As such, the illumination control engine 230 may operate the dimmable lamp(s) 206 to only supplement the direct sun light at each grow section 204 in order to comply with the illumination rule(s) rather than operating the dimmable lamps 206 to provide the entire illumination defined by the illumination rule(s) regardless of the natural sun light that may be available in at least some of the grow sections 204.

The illumination rules may define one or more illumination parameters, conditions and/or values for illumination of the grow sections 204. In particular, the illumination rules may be designed, defined and/to configured to control, maintain and/or ensure optimal illumination conditions for the plants and/or crops grown in the grow sections 204 of the greenhouse 202 in order to optimize the photosynthesis of the plants and/or crops.

For example, one or more illumination rules may define one or more certain levels of illumination that one or more of the grow sections 204 should be illuminated with, for example, a certain value of irradiance, a certain value of PPF, a certain value of PPFD, and/or the like. The defined illumination level may be different for different grow sections 204. In such case, the illumination control engine 230 may operate the dimmable lamps 206 to supplement the natural sun light illuminating each grow section 204 such that the level of the cumulative light of the sun and the respective dimmable lamp 206 complies with the level defined by the illumination rule(s).

In another example, assuming the dimmable lamps 206 are capable of emitting artificial illumination (light) in a plurality of spectral ranges (regions), one or more illumination rules may define one or more certain spectral ranges for illuminating one or more of the grow sections 204. In such case, the illumination control engine 230 may operate one or more of the dimmable lamps 206 to emit light (illumination) in the spectral range(s) defined by the illumination rule(s).

In another example, one or more illumination rules may define uniform illumination across the plurality of grow sections 204 in the greenhouse 202 such that all grow sections 204 may receive equal illumination. The illumination rule(s) may further define the level of the uniform. In such case, the illumination control engine 230 may operate the dimmable lamps 206 to supplement the natural sun light illuminating each grow section 204 such that the level of the sun light combined with the light projected by the respective dimmable lamp 206 are equal for all grow sections 204 across the greenhouse 202.

In another example, one or more illumination rules may define illuminating one or more of the plurality of grow sections 204 in the greenhouse 202 for certain times while avoiding illumination at other times. For example, a certain illumination rule(s) may define that the illumination control engine 230 should turn ON the dimmable lamps 206 associated with all grow sections 204 for a first time period, for example, 5 minutes, followed by second period, for example, 2 minutes of no illumination, i.e., the illumination control engine 230 should turn OFF all of the dimmable lamps 206. The ON and OFF time periods may be defined, determined and/or calculated to improve plants' growing conditions, for example, increase photosynthesis, without deteriorating other growing conditions.

Optionally, one or more of the illumination rules are adjusted according to one or more growth parameters of one or more plants and/or crops grown in the greenhouse 202. For example, assuming a certain crop grown in the greenhouse 202 requires different levels of illumination during different periods of its growth cycle, for example, low illumination level during a first period and higher illumination during a later period. In such case, the illumination rule(s) may be adjusted accordingly to define the lower illumination level during the first period of the crop's growth cycle and the higher illumination level during the later period of the crop's growth cycle.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms light sensor, geometric model, and ML model are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for controlling illumination in a greenhouse, comprising:
at least one processor configured to:
obtain a geometric model of a greenhouse comprising a grow space segmented to a plurality of grow sections each associated with a respective one of a plurality of dimmable lamps having an illumination area overlapping the respective grow section;
compute a shade model for the greenhouse based on the geometric model, the shade model defines, for each of the plurality of grow sections, a respective shading pattern indicative of a level of direct sun light in the respective grow section;
enhance the shade model using at least one machine learning model trained to predict the level of direct sun light in each grow section; and
operate at least one of the plurality of dimmable lamps based on the enhanced shade model to illuminate its associated grow section according to at least one illumination rule.

2. The system of claim 1, wherein the at least one illumination rule defines an illumination level of the at least one dimmable lamp.

3. The system of claim 1, wherein the at least one illumination rule defines at least one spectral range of artificial illumination of the at least one dimmable lamp.

4. The system of claim 1, wherein the at least one illumination rule defines operating the at least one dimmable lamp to emit a level of artificial illumination such that the level of a cumulative illumination comprising the direct sun light and the artificial illumination is uniform across the plurality of grow sections.

5. The system of claim 1, wherein the at least one illumination rule is adjusted according to at least one growth parameter of at least one crop grown in the greenhouse.

6. The system of claim 1, wherein the geometric model is created based on a mechanical structure of the greenhouse.

7. The system of claim 1, wherein the shading pattern of each grow section is indicative of the level of direct sun light in the respective grow section during all daytime.

8. The system of claim 1, further comprising adjusting the shade model according to at least one geolocation attribute of the greenhouse which potentially affects an angle of the sun with respect to at least one of the plurality of grow surfaces, the at least one geolocation attribute is a member of a group consisting of: latitude, longitude, altitude, and orientation.

9. The system of claim 1, further comprising adjusting the shade model according to at least one position attribute of the greenhouse which potentially affects an angle of the sun with respect to at least one of the plurality of grow surfaces, the at least one position attribute is a member of a group consisting of: an orientation, and a rotation.

10. The system of claim 1, wherein the at least one machine learning model is trained to predict the level of direct sun light illuminating each of the plurality of grow sections according to the level of direct sun light measured by at least one reference sensor deployed in the greenhouse.

11. The system of claim 10, wherein the at least one machine learning model is trained using at least one training dataset comprising a plurality of labeled training samples indicative of the level of direct sun light illuminating each of the plurality of grow sections with respect to the level of direct sun light measured by the at least one reference sensor.

12. The system of claim 11, wherein the plurality of labeled training samples are further indicative of the level of direct sun light illuminating each of the plurality of grow sections with respect to the level of direct sun light measured by the at least one reference sensor during all sun light hours of the day.

13. The system of claim 11, wherein at least some of the plurality of labeled training samples are captured by a plurality of light sensors deployed in a plurality of grow sections of at least one reference greenhouse representative of the greenhouse.

14. The system of claim 13, wherein at least some of the plurality of labeled training samples are adjusted according to at least one geolocation attribute of the greenhouse with respect to a respective geolocation attribute of the at least one reference greenhouse, the at least one geolocation attribute which potentially affects an angle of the sun with respect to at least one of the plurality of grow surfaces is a member of a group consisting of: latitude, longitude, altitude, and orientation.

15. The system of claim 13, wherein at least some of the plurality of labeled training samples are adjusted according to at least one position attribute of the greenhouse with respect to a respective position attribute of the at least one reference greenhouse, the at least one position attribute which potentially affects an angle of the sun with respect to at least one of the plurality of grow surfaces is a member of a group consisting of: an orientation, and a rotation.

16. The system of claim 13, further comprising capturing the at least some labeled training samples in a plurality of reference greenhouses deployed in a plurality of geolocations.

17. The system of claim 11, wherein at least some of the plurality of labeled training samples are captured by a plurality of light sensors temporarily deployed in the plurality of grow sections of the greenhouse.

18. The system of claim 11, wherein the at least one machine learning model is further trained online post deployment using a plurality of new labeled training samples captured by a plurality of light sensors deployed in at least one of the plurality of grow sections of the greenhouse.

19. The system of claim 1, wherein each of the plurality of dimmable lamps is powered by a respective one of a plurality of power drivers, each of the plurality of power drivers is individually controllable independently of any other of the plurality of power drivers.

20. A computer implemented method of controlling illumination in a greenhouse, comprising:
using at least one processor for:
obtaining a geometric model of a greenhouse comprising a grow space segmented to a plurality of grow sections each associated with a respective one of a plurality of dimmable lamps having an illumination area overlapping the respective grow section;
computing a shade model for the greenhouse based on the geometric model, the shade model defines, for each of the plurality of grow sections, a respective shading pattern indicative of a level of direct sun light in the respective grow section;
enhancing the shade model using at least one machine learning model trained to predict the level of direct sun light in each grow section; and
operating at least one of the plurality of dimmable lamps based on the enhanced shade model to illuminate its associated grow section according to at least one illumination rule.
